(19) United States
(12) Patent Application Publication
(10) Pub. No.: US 2026/0055264 A1
(43) Pub. Date: Feb. 26, 2026

(54) POLYOLEFIN COMPOSITION FOR HEAT SEALABLE FILMS

(71) Applicant: Basell Poliolefine Italia S.r.l., Milano (IT)

(72) Inventors: Monica Galvan, Ferrara (IT); Eleonora Ciaccia, Ferrara (IT); Alessia Di Capua, Ferrara (IT); Lelio Basile, Ferrara (IT)

(73) Assignee: Basell Poliolefine Italia S.r.l., Milano (IT)

(21) Appl. No.: 18/998,956

(22) PCT Filed: Jul. 10, 2023
(86) PCT No.: PCT/EP2023/068973

§ 371 Date: Jan. 27, 2025

(30) Foreign Application Priority Data
Aug. 3, 2022 (EP) 22188417.4

(51) Int. Cl. C08L 23/14; C08K 5/098; C08K 5/103; C08K 5/524

(52) U.S. Cl. CPC C08L 23/142; C08K 5/098; C08K 5/103; C08K 5/524; C08L 2203/162; C08L 2205/025; C08L 2205/03; C08L 2314/02

(57) ABSTRACT

A polypropylene composition (I) made from or containing:
(a) 20-45% by weight of a propylene-hexene copolymer;
(b) 25-45% by weight of a propylene-hexene-ethylene terpolymer; and
(c) 20-45% by weight of a propylene-ethylene copolymer,
wherein the amounts of (a), (b) and (c) are based on the total weight of (a)+(b)+(c).

### FIELD OF THE INVENTION

In general, the present disclosure relates to the field of chemistry. More specifically, the present disclosure relates to polymer chemistry. In particular, the present disclosure relates to a polyolefin composition for use in film applications.

### BACKGROUND OF THE INVENTION

In some instances, polypropylene heat sealable films are used in packaging applications. In some instances, the packaging applications include cigarette, candy, snack and food wraps. In some instances, polypropylene is used for shrink packaging, hygiene items and sterile wrap used in medical applications.

In some instances and in the packaging field, the polypropylene films are closed by heat sealing. Propylene homopolymers do not have good sealing properties. In some instances, the sealing properties of polypropylene is improved by using blends of propylene copolymers.

In some instances, blends of propylene-hexene copolymers and of copolymers of propylene and ethylene are used for preparing films. In some instances, the films are biaxially oriented polypropylene films (BOPP) and cast films.

### SUMMARY OF THE INVENTION

In a general embodiment, the present disclosure provides a polypropylene composition (I) made from or containing:
(a) from 20% to 45% by weight of a propylene-hexene copolymer having from 3.5% to less than 7.0% by weight of units deriving from hexene, based on the weight of (a);
(b) from 25% to 45% by weight of a propylene-hexene-ethylene terpolymer having from 6.0% to 12.0% by weight of units deriving from hexene and from 0.5% to 3.5% by weight of units deriving from ethylene, based on the weight of (b); and
(c) from 20% to 45% by weight of a propylene-ethylene copolymer having from 0.5% to 5.0% by weight of units derived from ethylene, based on the weight of (c),
wherein the amounts of (a), (b) and (c) are based on the total weight of (a)+(b)+(c), the total weight being 100.

In some embodiments, the present disclosure provides a film made from or containing the polypropylene composition (I). In some embodiments, the film is made from or containing the polypropylene composition (I) in at least one skin layer.

While multiple embodiments are disclosed, still other embodiments will become apparent to those skilled in the art from the following detailed description. As will be apparent, certain embodiments, as disclosed herein, are capable of modifications in various aspects, without departing from the spirit and scope of the claims as presented herein. Accordingly, the following detailed description is to be regarded as illustrative in nature and not restrictive.

### DETAILED DESCRIPTION OF THE INVENTION

In the present disclosure, the percentages are expressed by weight, unless otherwise specified.

In the present disclosure, the total weight of a (polypropylene) composition sums up to 100%, unless otherwise specified.

In the present disclosure, when the term “comprising” is referred to a polymer, a plastic material, a polymer composition, mixture or blend, the term should be construed to mean “comprising or consisting essentially of”.

In the present disclosure, the term “consisting essentially of” means that, in addition to the specified components, the plastic material, the polymer composition, the polymer mixture, or the polymer blend may be further made from or containing other components, provided that the characteristics of the material are not materially affected by the presence of the other components. In some embodiments, the other components are catalyst residues and processing aids.

In the present disclosure, the term “copolymer” is referred to a polymer deriving from the intentional polymerization of two different comonomers, that is, the term “copolymer” does not include terpolymers.

In the present disclosure, the term “terpolymer” is referred to a polymer deriving from the intentional polymerization of three different comonomers.

In the present disclosure, the term “hexene” refers to hexene-1 and the term “butene” refers to butene-1.

In the present disclosure, the term “skin layer” is referred to an outermost layer of a multilayer film.

In the present disclosure, the term “base layer” is referred to the innermost layer of a multilayer film. In some embodiments, at least one skin layer is adhered onto the base layer.

In some embodiments, the present disclosure provides a polypropylene composition (I) made from or containing:
(a) from 20% to 45% by weight, alternatively from 27% to 37% by weight, of a propylene-hexene copolymer having from 3.5% to less than 7.0% by weight of units deriving from hexene, based on the weight of (a);
(b) from 25% to 45% by weight, alternatively from 30% to 40% by weight, of a propylene-hexene-ethylene terpolymer having from 6.0% to 12.0% by weight of units deriving from hexene and from 0.5% to 3.5% by weight of units deriving from ethylene, based on the weight of (b); and
(c) from 20% to 45% by weight, alternatively from 27% to 37% by weight, of a propylene-ethylene copolymer having from 0.5% to 5.0% by weight of units derived from ethylene, based on the weight of (c),
wherein the amounts of (a), (b) and (c) are based on the total weight of (a)+(b)+(c), the total weight being 100.

In some embodiments, the polyolefin composition (I) is made from or containing the individual components in various combinations.

In some embodiments, the propylene-hexene copolymer (a) has from 4.0% to 6.5% by weight, alternatively from 4.5% to 6.0% by weight of units deriving from hexene, based on the weight of (a).

In some embodiments, the propylene-hexene copolymer (a) has at least one of the following properties:
from 9.0% to 20.0% by weight, alternatively from 10.0% to 17.0% by weight, of a xylene soluble fraction at 25° C. XS(a), based on the weight of (a); or
a melting temperature Tm(a), measured by DSC, ranging from 125° C. to 143° C., alternatively from 130° C. to 140° C., alternatively from 132° C. to 138° C.; or
a melt flow rate MFR(a), measured according to the method ISO 1133-1:2011 (230° C./2.16 kg), ranging from 3.5 to 8.5 g/10 min. In some embodiments, the propylene-hexene copolymer (a) has the previously-described properties.

In some embodiments, the propylene-hexene-ethylene terpolymer (b) has from 6.7% to 11.0% by weight, alternatively from 7.0% to 10.0% by weight, of units deriving from hexene and from 0.5% to 2.8% by weight, alternatively from 1.5% to 2.5% by weight, alternatively from 1.7% to 2.5% by weight, of units deriving from ethylene, wherein the amounts of units deriving from hexene and from ethylene are based on the weight of (b).

In some embodiments, the propylene-ethylene copolymer (c) has from 0.5 to less than 3.5% by weight, alternatively from 1.0% to 3.0% by weight, alternatively from 1.0% to 2.8% by weight, of units deriving from ethylene, based on the weight of (c).

In some embodiments, the polypropylene composition (I) is further made from or containing up to and including 5.0% by weight, alternatively from 0.01% to 5.0% by weight, of an additive (d) selected from the group consisting of nucleating agents, antistatic agents, anti-oxidants, light stabilizers, slipping agents, antiacids, melt stabilizers, and combinations thereof, the amount of additive being based on the total weight of the polypropylene composition (I) made from or containing the additive, the total weight being 100.

In some embodiments, the polypropylene composition (I) consists of components (a), (b), (c) and (d).

In some embodiments, the polypropylene composition (I) has at least one of the following properties:
from 12.0% to 20.0% by weight, alternatively from 14.0% to 17.0% by weight, of a xylene soluble fraction at 25° C. XS(I), based on the weight of the polypropylene composition (I); or
a melting temperature Tm(I), measured by DSC, ranging from 125° C. to 143° C., alternatively from 135° C. to 140° C.; or
a crystallization temperature Tc(I), measured by DSC, ranging from 85° C. to 100° C., alternatively from 89° C. to 95° C.; or
a melt flow rate MFR(I), measured according to the method ISO 1133-1:2011 (230° C./2.16 kg), ranging from 2.0 to 12.0 g/10 min, alternatively from 4.0 to 10.0 g/10 min, alternatively from 4.5 to 8.0 g/10 min. In some embodiments, the polypropylene composition (I) has the previously-described properties.

In some embodiments, the polypropylene composition (I) has a haze value, measured according to the method ASTM D1003 on BOPP films, of up to and including 1.00%, alternatively ranging from 0.20% to 1.00%.

In some embodiments, the polypropylene composition (I) has the total amount of hexene ranging from 3.0% to 7.0% by weight, alternatively from 3.5% to 6.0% by weight, and the total amount of ethylene ranging from 0.5% to 3.0% by weight, alternatively from 1.0% to 2.5% by weight, wherein the total amounts of hexene and ethylene are based on the weight of the polypropylene composition (I), the weight being 100.

In some embodiments, the polypropylene composition (I) is obtainable by melt blending the components (a), (b), (c) and optionally (d). In some embodiments, the polypropylene composition (I) is a reactor blend of the components (a), (b) and (c) optionally melt blended with component (d), wherein the reactor blend is obtained by polymerizing the relevant monomers in the gas-phase in at least three polymerization stages, wherein the second and each subsequent polymerization stage is carried out in the presence of the polymer produced and the catalyst system used in the immediately preceding polymerization stage.

In some embodiments, the polypropylene composition (I) is obtained by polymerizing the relevant monomers, in the presence of a highly stereospecific Ziegler-Natta catalyst systems made from or containing:
(1) a solid catalyst component made from or containing a magnesium halide support on which a Ti compound, having a Ti-halogen bond, is present, and a stereoregulating internal donor;
(2) optionally, an Al-containing cocatalyst; and
(3) optionally, a further electron-donor compound (external donor).

In some embodiments, the solid catalyst component (1) is made from or containing TiCl₄ in an amount securing the presence of from 0.5 to 10% by weight of Ti with respect to the total weight of the solid catalyst component (1).

In some embodiments, the solid catalyst component (1) is made from or containing a stereoregulating internal electron donor compound selected from mono or bidentate organic Lewis bases. In some embodiments, the solid catalyst component (1) is made from or containing a stereoregulating internal electron donor compound selected from the group consisting of esters, ketones, amines, amides, carbamates, carbonates, ethers, nitriles, alkoxysilanes and combinations thereof.

In some embodiments, the donors are the esters of phthalic acids. In some embodiments, the esters of phthalic acids are as described in European Patent Application Nos. EP45977A2 and EP395083A2. In some embodiments, the esters of phthalic acids are selected from the group consisting of di-isobutyl phthalate, di-n-butyl phthalate, di-n-octyl phthalate, diphenyl phthalate, benzylbutyl phthalate and combinations thereof.

In some embodiments, the esters of aliphatic acids are selected from the group consisting of esters of malonic acids, esters of glutaric acids, and esters of succinic acids. In some embodiments, the esters of malonic acids are as described in Patent Cooperation Treaty Publication Nos. WO98/056830, WO98/056833, and WO98/056834. In some embodiments, the esters of glutaric acids are as described in Patent Cooperation Treaty Publication No. WO00/55215. In some embodiments, the esters of succinic acids are as described in Patent Cooperation Treaty Publication No. WO00/63261.

In some embodiments, the stereoregulating internal electron donor compounds are diesters derived from esterification of aliphatic or aromatic diols. In some embodiments, the diesters are as described in Patent Cooperation Treaty Publication No. WO2010/078494 and U.S. Pat. No. 7,388,061.

In some embodiments, the internal donor is selected from 1,3-diethers. In some embodiments, the 1,3-diethers are as described in European Patent No. EP361493, European Patent No. EP728769 and Patent Cooperation Treaty Publication No. WO02/100904.

In some embodiments, the internal donor is a mixture of aliphatic or aromatic mono or dicarboxylic acid esters and 1,3-diethers as described in Patent Cooperation Treaty Publication Nos. WO07/57160 and WO2011/061134.

In some embodiments, the magnesium halide support is magnesium dihalide.

In some embodiments, the amount of internal donor that remains fixed on the solid catalyst component (1) is 5 to 20% by moles, with respect to the magnesium dihalide.

In some embodiments, the preparation of catalyst components is as described in U.S. Pat. Nos. 4,399,054, 4,469,648, Patent Cooperation Treaty Publication No. WO98/44009A1 or European Patent Application No. EP395083A2.

In some embodiments, the catalyst system is made from or containing an Al-containing cocatalyst (2) selected from Al-trialkyls. In some embodiments, the Al-containing cocatalyst (2) is selected from the group consisting of Al-triethyl, Al-triisobutyl and Al-tri-n-butyl. In some embodiments, the Al/Ti weight ratio in the catalyst system is from 1 to 1000, alternatively from 20 to 800.

In some embodiments, the catalyst system is further made from or containing electron donor compound (3) (external electron donor). In some embodiments, the external electron donor is selected from the group consisting of silicon compounds, ethers, esters, amines, heterocyclic compounds, and ketones. In some embodiments, the heterocyclic compound is 2,2,6,6-tetramethylpiperidine.

In some embodiments, the silicon compounds are selected from the group consisting of methylcyclohexyldimethoxysilane (C-donor), dicyclopentyldimethoxysilane (D-donor) and mixtures thereof.

In some embodiments, the polymerization temperature is in the range from 20° C. to 100° C. In some embodiments, the polymerization pressure is from 3.3 to 4.3 MPa, for a process in liquid phase, and from 0.5 to 3.0 MPa, for a process in the gas phase.

In some embodiments, the molecular weight of the polymers is regulated by feeding a molecular weight regulator into a polymerization reactor. In some embodiments, the molecular weight regulator is hydrogen.

In some embodiments, the propylene-hexene copolymer (a) is obtained in a first gas-phase reactor, the propylene-hexene-ethylene terpolymer (b) is obtained in a second gas-phase reactor in the presence of the polymer prepared and the catalyst system used in the first gas-phase reactor; and the propylene-ethylene copolymer (c) is obtained in a third gas-phase reactor in the presence of the polymer formed and the catalyst used in the preceding polymerizations steps.

In some embodiments, the polypropylene composition (I) is a reactor blend produced by sequential polymerization, wherein the amounts of components (a), (b) and (c) correspond to the split between the reactors.

In some embodiments, the polypropylene composition (I) is used for producing films, alternatively heat sealable films.

As used herein, the term “ΔTm-SIT” refers to the difference between the Tm(I) and the SIT of the polypropylene composition (I) measured on a BOPP film.

In some embodiments, the ΔTm-SIT value ranges from 30° to 45° C., alternatively from 30° to 40° C., wherein the Tm(I) and the SIT.

In some embodiments, the present disclosure provides a film made from or containing the polypropylene composition (I).

In some embodiments, the film is a multilayer film made from or containing a base layer and at least one skin layer, wherein the skin layer is made from or containing the polypropylene composition (I).

In some embodiments, the base layer is made from or containing a polyolefin. In some embodiments, the base layer is made from or containing a polypropylene selected from the group consisting of propylene homopolymers, propylene copolymers and combinations thereof.

In some embodiments, the film is an unoriented film, alternatively a cast film or a blown film.

In some embodiments, the film is an oriented film, alternatively a biaxially oriented polypropylene (BOPP) film.

In some embodiments, the film has a total film thickness ranging from 10 to 70 microns, alternatively from 15 to 30 microns, alternatively from 18 to 22 microns.

In some embodiments, the film has at least one of the following properties:
a seal initiation temperature (SIT) equal to or lower than 105° C., alternatively lower than 105° C., alternatively ranging from 900 to 105° C., alternatively from 950 to 103° C., alternatively from 970 to 102° C.; or
a seal strength at 130° C. ranging from 3.0 to 4.5 N; or
hot tack at 110° C. ranging from 400 to 600 N, alternatively from 460 to 560 N; or
gloss on BOPP film ranging from 83 to 95, alternatively from 85 to 90. In some embodiments, the film has the previously-described properties.

In some embodiments, the features are not inextricably linked to each other. In some embodiments, ranges of a feature are combined with ranges of a different feature, independently.

### EXAMPLES

The following examples are illustrative and not intended to limit the scope of the disclosure in any manner whatsoever.

CHARACTERIZATION METHODS: the following methods are used to determine the properties indicated in the description, claims and examples.

Melt Flow Rate: Determined according to the method ISO 1133-1:2011 (230° C./2.16 kg for the propylene polymers and 190° C./2.16 kg for the butene-1 copolymer).

Solubility in xylene at 25° C. for propylene polymers: 2.5 g of polymer sample and 250 ml of xylene were introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minutes under stirring. In the second stage, the flask was transferred to a thermostatically-controlled water bath at 25° C. for 30 minutes. The temperature was lowered to 25° C., without stirring during the first 20 minutes, and maintained at 25° C., with stirring for the last 10 minutes. The formed solid was filtered on quick filtering paper (for example, Whatman filtering paper grade 4 or 541). 100 ml of the filtered solution (Si) was poured into a pre-weighed aluminum container, which was heated to 140° C. on a heating plate under nitrogen flow, thereby removing the solvent by evaporation. The container was then kept in an oven at 80° C. under vacuum until constant weight was reached. The amount of polymer soluble in xylene at 25° C. was then calculated. XS(I) and XS_{A} values were experimentally determined. The fraction of component (B) soluble in xylene at 25° C. (XS_{B}) was calculated from the formula:

$$X S = W ( A ) \times ( X {S}_{A} ) + W ( B ) \times ( X {S}_{B} )$$

wherein W(A) and W(B) are the relative amounts of components (A) and (B), respectively, and W(A)+W(B)=1.

Comonomer content of the polypropylene composition: determined by IR using Fourier Transform Infrared Spectrometer (FTIR). The spectrum of a pressed film of the polymer was recorded in absorbance vs. wavenumbers (cm-1). The following measurements were used to calculate ethylene and hexene-1 content:
Area (At) of the combination absorption bands between 4482 and 3950 cm-1 which was used for spectrometric normalization of film thickness;
a linear baseline was subtracted in the range 790-660 cm-1, and the remaining constant offset was eliminated; and
the contents of ethylene and hexene-1 were obtained by applying a Partial Least Square (PLS1) multivariate regression to the 762-688 cm-1 range.
   The method was calibrated using polymer standards based on 13C NMR analyses.
   Sample preparation: Using a hydraulic press, a thick sheet was obtained by pressing about Ig of sample between two aluminum foils. Pressing temperature was 180±10° C. (356° F.) with about 10 kg/cm2 of pressure for about one minute. There was a minimum of two pressing operations for each specimen. A small portion was cut from the sheet to mold the film. The film thickness was between 0.02-0.05 cm.

Comonomer content of butene-ethylene copolymers: ¹³C NMR spectra were acquired on a Bruker AV-600 spectrometer equipped with cryoprobe, operating in the Fourier transform mode at 120° C. The samples were dissolved in 1,1,2,2-tetrachloroethane-d2 at 120° C. with an 8% wt/v concentration. Each spectrum was acquired with a 900 pulse, and 15 seconds of delay between pulses and CPD, thereby removing 1H-13C coupling. The spectrometer was operated at 160.91 MHz. The peak of the Sδδ carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as an internal standard at 29.9 ppm. 512 transients were stored in 32K data points using a spectral window of 9000 Hz.

The assignments of the spectra, the evaluation of triad distribution and the composition were made according to Kakugo [M. Kakugo, Y. Naito, K. Mizunuma and T. Miyatake, Macromolecules, 16, 4, 1160 (1982)] and Randall [J. C. Randall, Macromol. Chem Phys., C30, 211 (1989)] using the following:

$$\begin{matrix}\begin{matrix}BBB = 100 {T}_{β β} / S & BBE = 100 {T}_{β β} / S & EBE = 100 {P}_{δδ} / S \\ BEB = 100 {S}_{β β} / S & BEE = 100 {S}_{α δ} / S & EEE = 100 ( 0.25 {S}_{γ δ} + 0.5 {S}_{δδ} ) / S\end{matrix} \\ S = {T}_{β β} + {T}_{β δ} + {P}_{δδ} + {S}_{β β} + {S}_{α δ} + 0.25 {S}_{γ δ} + 0.5 {S}_{δδ}\end{matrix}$$

The total amount of 1-butene and ethylene, as molar percent, was calculated from triad using the following relations:

$$[ E ] = E E E + B E E + B E B [ B ] = B B B + B B E + E B E$$

The weight percentage of ethylene content (E % wt) was calculated using the following equation:

$$E \% wt = \frac{[ E ] mol \times MWE}{( [ E ] mol \times MWE ) + ( [ B ] mol \times MWB )} \times 100$$

$$wherein \\ mol = the molar percentage of 1 - butene content ; \\ MWE = molecular weights of ethylene \\ MWB = molecular weight of 1 - butene .$$

Molecular weight distribution Mw/Mn: The determination of the means Mn and Mw, and Mw/Mn derived therefrom was carried out using a Waters GPCV 2000 apparatus, which was equipped with a column set of four PLgel Olexis mixed-gel (Polymer Laboratories) and an IR4 infrared detector (PolymerChar). The dimensions of the columns were 300×7.5 mm with particle size 13 μm. The mobile phase used was 1-2-4-trichlorobenzene (TCB) with a flow rate at 1.0 ml/min. The measurements were carried out at 150° C. Solution concentrations were 0.1 g/dl in TCB and 0.1 g/l of 2,6-di-tert-butyl-p-cresole were added, thereby preventing degradation. For GPC calculation, a universal calibration curve was obtained using 10 polystyrene (PS) standard samples supplied by Polymer Laboratories (peak molecular weights ranging from 580 to 8500000). A third order polynomial fit was used to interpolate the experimental data and obtain the calibration curve. Data acquisition and processing were done using Empower (Waters). The Mark-Houwink relationship was used to determine the molecular weight distribution and the relevant average molecular weights: the K values were KPS=1.21×10-4 dL/g and KPB=1.78×10-4 dL/g for PS and PB respectively, while the Mark-Houwink exponents α=0.706 for PS and α=0.725 for PB were used. For butene-1/ethylene copolymers, the composition was assumed constant in the whole range of molecular weights and the K value of the Mark-Houwink relationship was calculated using a linear combination:

$${K}_{EB} = {x}_{E} {K}_{PE} + {x}_{P} {K}_{PB}$$

where K_{EB} was the constant of the copolymer, K_{PE} (4.06×10⁻⁴, dL/g) and K_{PB} (1.78×10⁻⁴ dl/g) were the constants of polyethylene and polybutene and xE and xB were the ethylene and the butene-1 weight % content. The Mark-Houwink exponent α=0.725 was used for the butene-1/ethylene copolymers.

Melting temperature: measured according to the method ISO 11357-3:2018. Polypropylene and polypropylene compositions: scanning rate of 20° C./min in cooling and heating, on a sample weighing 5-7 mg, under nitrogen flow. Instrument calibration was made with Indium. Polybutene: To determine the melting temperature of the polybutene crystalline form I (Tm(I)), the sample was melted, kept at 200° C. for 5 minutes, and then cooled down to 20° C. with a cooling rate of 10° C./min. The sample was then stored for 10 days at room temperature. After 10 days, the sample was subjected to DSC. The sample was cooled to −20° C. and then heated at 200° C. with a scanning speed corresponding to 10° C./min. In this heating run, the first peak temperature coming from the lower temperature side in the thermogram was taken as the melting temperature Tm(I).

Flexural Modulus: determined according to the method ISO 178:2010 on injection molded test specimens (80×10×4 mm) obtained according to the method ISO 1873-2:2007 for propylene polymers or on compression molded specimens for butene polymers. Specimens of butene copolymers were conditioned for 10 days at 23° C. before testing.

Preparation of BOPP film test specimens. Films with thickness of 50 μm were prepared by extruding each test composition in a single screw Collin extruder (length/diameter ratio of screw 1:25) at a film drawing speed of 7 m/min and a melt temperature of 210-250° C. Each film was superimposed on a 1000 μm thick film of a propylene homopolymer, having a xylene insoluble fraction of 97 wt % and a MFR (IS01133-1:2011, 230° C./2.16 kg) of 2.0 g/10 min. The superimposed films were bonded to each other in a plat press at 200° C. under a 35 kg×cm² load, which was maintained for 5 minutes. The resulting laminates were simultaneously stretched longitudinally and transversally, that is, biaxially, by a factor 7 with a Karo 4 Brueckener film stretcher at 160° C., thereby obtaining a 20 μm thick BOPP film (18 μm homopolymer+2 μm test composition).

Seal strength and seal initiation temperature (SIT): Film strips, 6×35 cm, were cut from the center of the BOPP test specimens. Two film strips are superimposed. The strips were covered with 50 micron Teflon® foil and sealed by a RDM Heat Sealer, in the following conditions: smooth metallic sealing bars, both bars heated; sealing time 0.5 sec.; sealing pressure of 0.14 MPa (20 psi). After at least 10 minutes of conditioning time at 23° C. and 50% Relative Humidity (R.H.), six test specimens were cut from each sealed strip, 15 mm wide, of a length for clamping in the tensile tester grips. The seal strength at a given temperature was tested with a dynamometer at a load cell capacity 100 N, cross speed 100 mm/min and grip distance 50 mm. The seal strength value was the average of 6 measurements on the same film sample. The test was repeated by increasing or decreasing the temperature by 1° or 2° C. As used herein, the lowest temperature at which a seal strength equal to or greater than 1.5N was achieved is defined as the sealing initiation temperature SIT.

Determination of the hot tack. Hot tack was measured after sealing the BOPP test specimens with a Brugger HSG Heat-Sealer (with Hot Tack kit) at a pressure of 0.12 MPa (18 psi) for 5 sec. Films were cut at a minimum length of 15×200 mm, superimposed, and sealed at different temperatures, starting at 80° C. and increasing the sealing temperature by 5° C. Immediately after sealing, the test specimen were pulled onto a mandrel by a pulley to split the hot seal seam. For each sealing temperature, the force to split the hot sealed seam at half length (hot tack) was determined using different drop weights made to impact the test specimens.

Haze: measured on ASTM D1003 on 50 μm cast films.

Gloss: ASTM D2457 (angle 45°) on 50 μm cast films and on BOPP films.

### Raw Materials:

Adsyl 5C30F: a polyolefin commercially available from LyondellBasell, designed for use as sealing layer in coextruded film applications.

Irganox 1010: Pentaerythritol tetrakis (3-(3,5-di-tert-butyl-4-hydroxyphenyl) propionate) commercially available from BASF.

Irgafos 168: tris(2,4-di-tert.-butylphenyl) phosphite commercially available from BASF.

### Examples E1-E4 and Comparative Examples CE5-CE6

Preparation of the catalyst system: for the preparation of the polypropylene compositions, a Ziegler-Natta catalyst system was made from or containing
a titanium-containing solid catalyst component, prepared with the procedure described in European Patent No. EP728769, Example 1, according to which 9,9-bis(methoxymethyl)fluorene was used as internal electron donor compound;
triethylaluminium (TEAL) as co-catalyst; and
dicyclopentyl dimethoxy silane (DCPMS) as external electron donor.

The solid catalyst component was contacted with TEAL and DCPMS in a pre-contacting vessel, in the conditions reported in Table 1.

Polymerization: before entering the catalyst system into the first polymerization reactor, the catalyst system was prepolymerized by maintaining the catalyst system in suspension in liquid propylene at 20° C. for 20 minutes. In the first gas phase polymerization reactor, the propylene-hexene copolymer (a) was produced by feeding a continuous and constant flow of the prepolymerized catalyst system, hydrogen as molecular weight regulator, and propylene and hexene in gas state. The propylene-hexene copolymer produced in the first gas phase reactor was continuously discharged from the first reactor and introduced, together with a quantitatively constant flow of hydrogen, propylene, hexene and ethylene in the gas state, into the second gas phase polymerization reactor. The propylene-hexene-ethylene terpolymer was produced in the second reactor. The polymer produced in the second gas phase reactor was discharged in a continuous flow from the second reactor and, after purging of unreacted monomers, introduced, in a continuous flow, into the third gas phase polymerization reactor, together with quantitatively constant flows of hydrogen, ethylene and propylene in the gas state. The polymerization conditions were reported in Table 1.

TABLE 1

| | | E1 | E2 | E3 | E4 | CE5 |
|---|---|---|---|---|---|---|
| Catalyst feed | g/h | 19.5 | 19.4 | 20.0 | 19.6 | 19.3 |
| TEAL/solid | g/g | 3 | 3 | 3 | 3 | 3 |
| catalyst | | | | | | |
| TEAD/Donor | g/g | 10 | 10 | 10 | 10 | 10 |
| D | | | | | | |

GPR1

| | | | | | | |
|---|---|---|---|---|---|---|
| Temperature | ° C. | 72 | 72 | 72 | 72 | 72 |
| Pressure | barg | 16 | 16 | 16 | 16 | 16 |
| H2/C3 | mol/mol | 0.0007 | 0.0007 | 0.0003 | 0.001 | 0.0007 |
| C6/C3 + C6 | mol/mol | 0.051 | 0.041 | 0.041 | 0.04 | 0.025 |
| split | | 34 | 32 | 31 | 31 | 34 |
| C6 (GPR1)# | wt. % | 4.9 | 5.0 | 4.9 | 4.8 | 3.1 |

GPR2

| | | | | | | |
|---|---|---|---|---|---|---|
| Temperature | ° C. | 72 | 72 | 72 | 72 | 72 |
| Pressure | barg | 15 | 15 | 15 | 15 | 15 |
| H2/C3 | mol/mol | 0.009 | 0.009 | 0.012 | 0.010 | 0.014 |
| C6/C3 + C6 | mol/mol | 0.053 | 0.051 | 0.056 | 0.033 | 0.046 |
| C2/C2 + C3 | mol/mol | 0.026 | 0.021 | 0.021 | 0.017 | 0.023 |
| split | | 34 | 34 | 32 | 32 | 36 |
| C2 (GPR2)# | wt. % | 1.3 | 1.0 | 1.1 | 1.0 | 1.2 |
| C6 (GPR2)# | wt. % | 5.9 | 6.3 | 6.3 | 6.0 | 4.9 |

GPR3

| | | | | | | |
|---|---|---|---|---|---|---|
| Temperature | ° C. | 65 | 65 | 65 | 65 | 65 |
| Pressure | barg | 14 | 14 | 14 | 14 | 14 |
| H2/C3 | mol/mol | 0.014 | 0.012 | 0.012 | 0.007 | 0.012 |
| C2/C2 + C3 | mol/mol | 0.025 | 0.023 | 0.020 | 0.029 | 0.026 |
| split | | 32 | 34 | 37 | 37 | 30 |
| C2 (GPR3)# | wt. % | 1.5 | 1.1 | 1.4 | 1.7 | 1.6 |
| C6 (GPR3)# | wt. % | 4.5 | 4.7 | 3.9 | 4.1 | 3.4 |

H2 = hydrogen;
C3 = propylene;
C2 = ethylene;
C6 = hexene
#are values measured on powders sampled in the respective reactor

The polymers obtained from the polymerization runs were combined with the additives of 0.05 wt. % of Irganox 1010, 0.1 wt. % of Irgafos 168, and 0.05% of calcium stearate, wherein the amounts of the additives were based on the total weight of the polymers including the additives. The resulting polypropylene composition was pelletized. Table 2 illustrates the features of the polypropylene compositions.

In comparative example, CE6 Adsyl 5C30F was used.

TABLE 2

| | | | | | |
|---|---|---|---|---|---|
| E1 | E2 | E3 | E4 | CE5 | CE6 |

Component (a)

| | | | | | | |
|---|---|---|---|---|---|---|
| split | wt. % | 34 | 32 | 31 | 31 | 34 |
| C6(a) | wt. % | 4.9 | 5.0 | 4.9 | 4.8 | 3.1 |
| MFR | g/10 min | 5.9 | 5.9 | 6.0 | 5.8 | 6.3 |
| XS(a) | wt. % | 11.0 | 10.1 | 11.1 | 14.1 | 3.6 |
| Tm(a) | ° C. | 139.5 | 138.2 | 138.2 | 138.6 | 143.5 |

Component (b)

| | | | | | | |
|---|---|---|---|---|---|---|
| split | wt. % | 34 | 34 | 32 | 32 | 36 |
| C6(b)* | wt. % | 6.9 | 7.5 | 7.7 | 7.2 | 6.6 |
| C2(b)* | wt. % | 2.6 | 1.9 | 2.2 | 2.0 | 2.3 |

Component (c)

| | | | | | | |
|---|---|---|---|---|---|---|
| split | wt. % | 32 | 34 | 37 | 37 | 30 |
| C2(c)* | wt. % | 1.9 | 1.3 | 1.9 | 2.9 | 2.5 |

Polypropylene composition

| | | | | | | | |
|---|---|---|---|---|---|---|---|
| C6 | wt. % | 4.5 | 4.7 | 3.9 | 4.1 | 3.4 | — |
| C2 | wt. % | 1.5 | 1.1 | 1.4 | 1.7 | 1.6 | — |
| MFR(I) | g/10 min | 5.6 | 4.9 | 5.5 | 5.1 | 5.6 | 5.5 |
| XS(I) | wt. % | 17.7 | 15.9 | 13.5 | 12.7 | 13.2 | — |
| Tm(I) | ° C. | 134.4 | 135.4 | 137.4 | 132.9 | 136.4 | 132 |
| Tc(I) | ° C. | 90.3 | 91.0 | 92.6 | 89.9 | 93.4 | — |
| SIT on BOPP | ° C. | 99 | 98 | 100 | 101 | 107 | 105 |
| gloss (45°) on | | 89 | 89 | 88 | 89 | 88 | 88 |
| 50 μm cast film | | | | | | | |
| haze on 50 μm | | 0.2 | 0.3 | 0.3 | 0.2 | 0.3 | 0.6 |
| cast film | | | | | | | |
| gloss (45°) on | | 89 | 87 | 88 | 86 | 88 | — |
| BOPP film | | | | | | | |
| Seal strength at | N | 3.6 | 4.1 | 3.7 | 3.5 | — | 3.5 |
| 130° C. | | | | | | | |
| Hot tack at 110° | N | 560 | 468 | 448 | 563 | 375 | 513 |
| C. | | | | | | | |

C2 = ethylene;
C6 = hexene
*values calculated with the formulas:
C6(GPR2) = W(a)C6(GRP1) + W(b)C6(b),
C2(GPR2) = W(b)C2(b)
C2(GPR3) = W(a + b)C2(GPR2) + W(c)C2(c)
wherein
C6(GPR2) is the total measured amount of C6 of the polymer exiting the GPR2;
C6(GPR1) is the measured amount of C6 of the polymer exiting the GPR1;
W(a) = split(GPR1)/split(GPR1) + split(GPR2);
W(b) = split(GPR2)/split(GPR1) + split(GPR2);
C2(GPR2) is the measured amount of C2 of the polymer exiting the GPR2;
C2(GPR3) is the total measured amount of C2 of the polymer exiting the GPR3;
W(a + b) = (split(GPR1) + split(GPR2))/100
W(c) = split(GPR3)/100

What is claimed is:

1. A polypropylene composition (I) comprising:
(a) from 20% to 45% by weight of a propylene-hexene copolymer having from 3.5% to less than 7.0% by weight of units deriving from hexene, based on the weight of (a);
(b) from 25% to 45% by weight of a propylene-hexene-ethylene terpolymer having from 6.0% to 12.0% by weight of units deriving from hexene and from 0.5% to 3.5% by weight of units deriving from ethylene, based on the weight of (b); and
(c) from 20% to 45% by weight by of a propylene-ethylene copolymer having from 0.5% to 5.0% by weight of units derived from ethylene, based on the weight of (c),
wherein the amounts of (a), (b) and (c) are based on the total weight of (a)+(b)+(c).

2. The polypropylene composition (I) according to claim 1, wherein the propylene-hexene copolymer (a) has 4.0% to 6.5% by weight of units deriving from hexene, based on the weight of (a).

3. The polypropylene composition (I) according to claim 1, wherein the propylene-hexene-ethylene terpolymer (b) has from 6.7% to 11.0% by weight of units deriving from hexene and from 0.5% to 2.8% by weight of units deriving from ethylene, based on the weight of (b).

4. The polypropylene composition (I) according to claim 1, wherein the propylene-ethylene copolymer (c) has from 0.5% to less than 3.5% by weight of units deriving from ethylene, based on the weight of (c).

5. The polypropylene composition (I) according to claim 1, wherein the polypropylene composition (I) has from 12.0% to 20.0% by weight of a xylene soluble fraction at 25° C. XS(I), based on the weight of the polypropylene composition (I).

6. The polypropylene composition (I) according to claim 1, wherein the polypropylene composition (I) has a melting temperature Tm(I), measured by DSC, ranging from 125° C. to 143° C.

7. The polypropylene composition (I) according to claim 1, wherein the polypropylene composition (I) has a crystallization temperature Tc(I), measured by DSC, ranging from 85° C. to 100° C.

8. The polypropylene composition (I) according to claim 1, wherein the polypropylene composition (I) has a melt flow rate MFR(I), measured according to the method ISO 1133-1:2011 (230° C./2.16 kg), ranging from 2.0 to 12.0 g/10 min.

9. A film comprising the polypropylene composition (I) according to claim 1.

10. The film according to claim 9, being a multilayer film comprising a base layer and at least one skin layer, wherein the skin layer comprises the polypropylene composition (I).

11. The film according to claim 9, wherein the film is unoriented.

12. The film according to claim 9, wherein the film is an oriented film.

13. The film according to claim 9, wherein the total film thickness ranges from 10 to 70 microns.

14. The multilayer film according to claim 10, having at least one of the following properties:
a seal initiation temperature (SIT) equal to or lower than 105° C.;
a seal strength at 130° C. ranging from 3.0 to 4.5 N;
hot tack at 110° C. ranging from 400 to 600 N.
